(19) United States
(12) Patent Application Publication
(10) Pub. No.: US 2005/0011726 A1
(43) Pub. Date: Jan. 20, 2005

(54) Product transfer system and method

(76) Inventors: Eric L. Kuhne, New Berlin, WI (US); David T. Quadracci, Brookfield, WI (US); Brian Erdmann, Florence, WI (US)

Correspondence Address: Michael Best & Friedrich LLP, 100 East Wisconsin Avenue, Milwaukee, WI, 53202-4108, US

(21) Appl. No.: 10/623,144

(22) Filed: Jul. 18, 2003

(51) Int. Cl. B65G 47/24

(52) U.S. Cl. 198/373

(57) ABSTRACT

The invention recites an apparatus and method that includes a first conveyor adapted to convey a first stream of products and a gapper positioned adjacent the first conveyor to receive the first stream. The gapper reorients the first stream into a vertical queue of products. The apparatus and method also includes a second conveyor selectively operable to clutch the bottom surface of exposed products and advance the products to define a second shingled stream. A third conveyor receives the second shingled stream from the second conveyor and transfers it to a process device. The third conveyor has an operating speed that is variable and that is selectively different than the operating speed of the second conveyor.

### BACKGROUND OF THE INVENTION

The present invention relates to an apparatus and method for transporting products, and particularly to an apparatus and method for forming a uniform shingled stream of products. More particularly the present invention relates to an apparatus and method for placing a gap in a uniform shingled stream of products.

Streams of products such as printed signatures are commonly used during printing or binding to allow for easy separation of individual signatures and to facilitate transfer from one point to another. In some processes, it is necessary to store signatures for later use or to facilitate transportation to another plant or location. Typically, the signatures are placed in a vertical stack or log that is compressed, bound, and stored until needed.

A conveyor feeds signatures in a stream to a stacker that collects and stacks the signatures to form a log. When a log is complete, it is bound and removed from the stacking position. In addition, a new log is prepared to receive the signatures. During this transition, it is generally necessary to stop the feed of signatures to the stacker.

### SUMMARY OF THE PREFERRED EMBODIMENT

The present invention provides an apparatus that includes a first conveyor adapted to convey a first stream of products and a gapper positioned adjacent the first conveyor to receive the first stream. The gapper reorients the first stream of products into a vertical queue. The apparatus also includes a second conveyor selectively operable to clutch the bottom surface of exposed products and advance the products to define a second shingled stream. A third conveyor receives the second shingled stream from the second conveyor and transfers it to a process device. The third conveyor has an operating speed that is variable and that is selectively different than the operating speed of the second conveyor.

In another embodiment, the invention provides an apparatus operable to produce a shingled stream of products having a desired product spacing. The apparatus includes a conveyor disposed beneath a vertical queue of products. The conveyor has a plurality of substantially equally spaced apertures. A vacuum plate is disposed beneath the conveyor, in fluid communication with a vacuum source and includes a plurality of apertures alignable with the plurality of apertures of the second conveyor. The vacuum plate is movable between a first position and a second position. When the vacuum plate is in the first position the second conveyor clutches an exposed bottom surface of the products in the queue to advance the products and produce a shingled stream having a first spacing and when the vacuum plate is in the second position the second conveyor clutches the exposed bottom surfaces of the products in the queue and advances the products to produce a shingled stream of products having a second spacing.

In yet another embodiment, the invention provides an apparatus including a first conveyor operable to deliver a first shingled stream of printed products and a gapper positioned adjacent the first conveyor to receive the first shingled stream and reorient the printed products into a vertical queue. A second conveyor includes a plurality of apertures therein and an advancement leg movable in an advancement direction. A vacuum plate is disposed beneath the advancement leg. The vacuum plate includes a plurality of vacuum apertures and is movable parallel to the advancement direction. The vacuum apertures are in fluid communication with a vacuum source such that the vacuum apertures cooperate with the apertures in the second conveyor to sequentially clutch and advance each of the printed products in the queue. A third conveyor is positioned to receive the printed products from the second conveyor, and deliver the printed products as a second shingled stream having a spacing.

In another construction, the invention provides a method of changing the spacing between adjacent products in a stream of products. The method includes orienting the products in a vertical queue and passing a conveyor having a plurality of substantially equally spaced apertures beneath the queue. The method also includes fluidly connecting a first aperture with a vacuum source as it reaches a first point such that it clutches a first product in the queue and advancing the conveyor to advance the first product a first distance. The method further includes exposing a portion of a second product immediately above the first product adjacent the first point and fluidly connecting a second aperture with the vacuum source as it reaches the first point such that it clutches the exposed portion of the second product immediately above the first product and advances the second product to define a shingled stream. The method also includes moving an adjusting member to move the first point relative to the queue to adjust the spacing between adjacent products.

The invention also provides a method of providing a gap in a stream of products. The method includes positioning a support member in the path of the stream of products, the support member receiving the stream from a first conveyor and reorienting them into a vertical queue supported on the support member. The method also includes operating a second conveyor having a plurality of equally spaced apertures therein and providing a vacuum to at least one of the apertures such that the at least one aperture clutches a first product in the vertical queue and advances the product to produce a second shingled stream. The method includes operating a third conveyor to conduct the second shingled stream away from the second conveyor and selectively interrupting the second shingled stream from advancing to the third conveyor to define the gap.

In yet another construction, the invention provides a method of producing a product log. The method includes feeding a first stream of products to a queue, vertically stacking the products in the queue, and removing individual products from the bottom of the queue to produce a second shingled stream having a spacing between adjacent products. The method also includes feeding the second shingled stream from a conveyor to a stacker, accelerating the conveyor to substantially deplete the queue to complete the product log, and stopping the feeding of products from the queue to the conveyor to define a gap in the second shingled stream. The method also includes restarting the feeding of products from the queue to the second shingled stream to begin a new log.

### BRIEF DESCRIPTION OF THE DRAWINGS

The detailed description particularly refers to the accompanying figures in which:

FIG. 1 is a top view of a conveyor system including a gapper section;

FIG. 2 is a side view of the conveyor system of FIG. 1;

FIG. 3 is a perspective view of the gapper section of FIG. 1;

FIG. 4 is a top view of the gapper section of FIG. 1;

FIG. 5 is a side view of the gapper section of FIG. 1 illustrating movement of the support member assembly in response to a paper jam;

FIG. 6 is a perspective view of a support member assembly of the gapper of FIG. 1;

FIG. 7 is a perspective view of a stop member assembly of the gapper of FIG. 1;

FIG. 8 is a rear view of the stop member assembly of FIG. 7;

FIG. 9 is a schematic representation illustrating three different product spacing in a shingled stream of products;

FIG. 10 is a schematic representation of the transfer system in the process of forming a log;

FIG. 11 is a schematic representation of the transfer system in the process of completing a log after placing a gap in the second shingled stream.

### DETAILED DESCRIPTION OF THE DRAWINGS

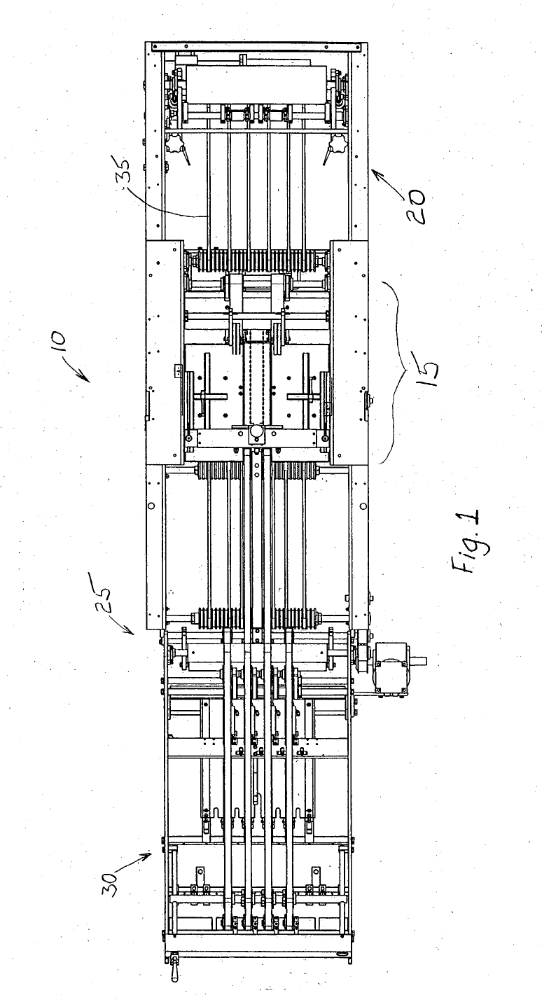

FIGS. 1, 10 and 11 illustrate a product transfer system 10 including a gapper section 15, an input conveyor section 20, an output conveyor section 25, and a process section 30.

The input conveyor section 20 includes a plurality of belts 35 positioned to transport a stream of products 37. The invention will hereinafter be described in conjunction with the use of printed products, for example, signatures. However, it should be understood that products other than printed products, such as plastic sheets or paper, and printed products other than signatures can be used with the present invention. Many different input conveyor arrangements can be used so long as the input conveyor 20 is able to deliver signatures to the gapper section 15 at a substantially constant rate. Some constructions may include variable speed conveyors 20 to allow for variation in the rate of delivery of signatures to the gapper section 15. The actual arrangement and configuration of the input conveyor section 20 is not important to the function of the invention. Rather, the input conveyor 20 need only function to deliver signatures to the gapper section 15 in a stream. In some arrangements, the stream is preferably a shingled stream although non-shingled streams can also be employed.

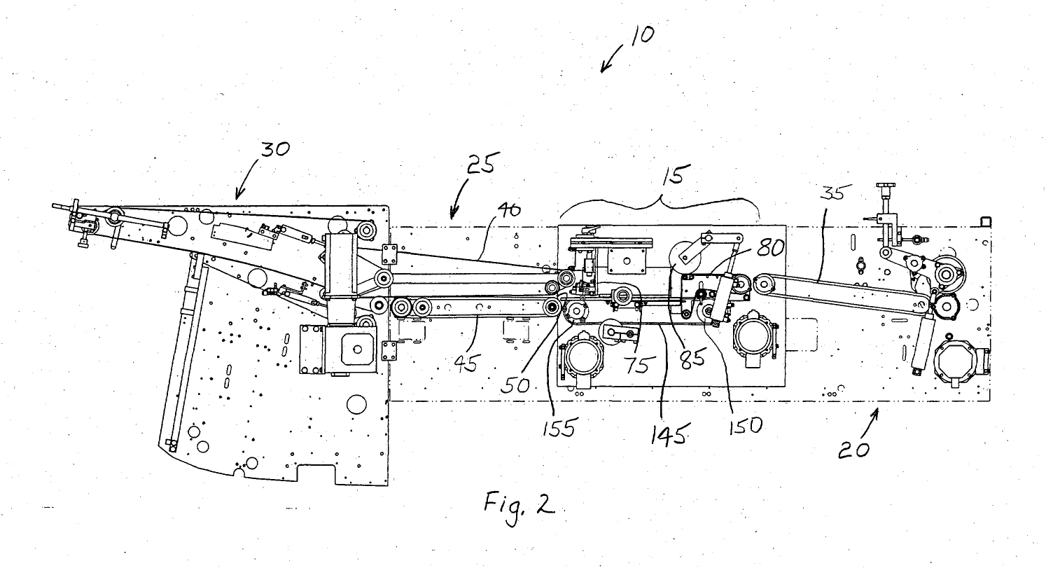

The output conveyor section 25 receives a second shingled stream of signatures 38 from the gapper section 15 and delivers the stream 38 to the process section 30. The output conveyor section 25 includes upper belts 40 and lower belts 45 positioned to define an inlet nip point 50 (shown best in FIG. 2). As signatures exit the gapper 15, they are captured in the nip point 50 and transported between the belts 40, 45.

The belts of the output conveyor section 40, 45 are driven by variable speed drives that allow for varying speeds of transport within the output conveyor 25. The function and importance of the variable speed drive will be described below in conjunction with the operation of the gapper 15.

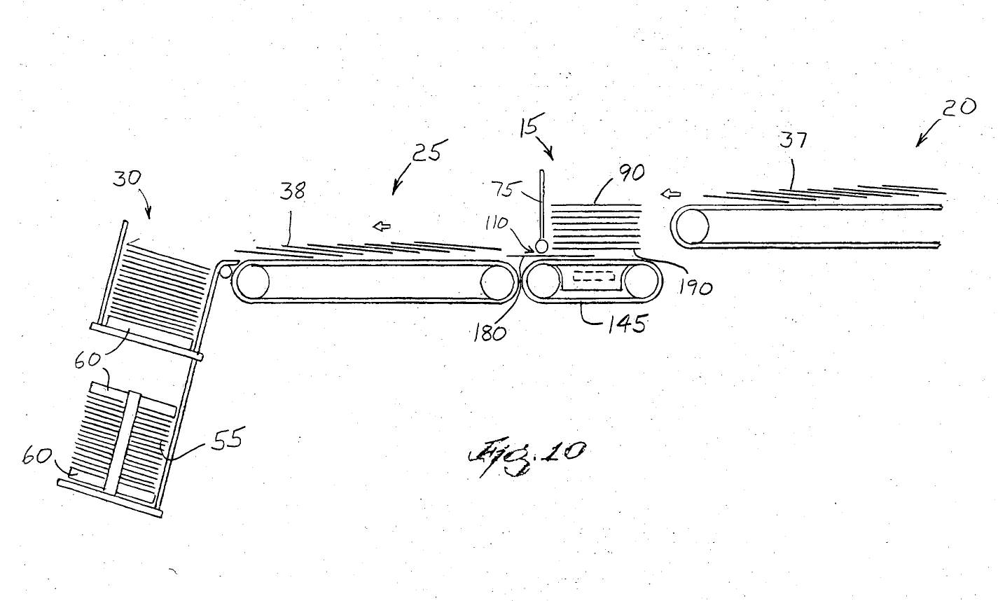

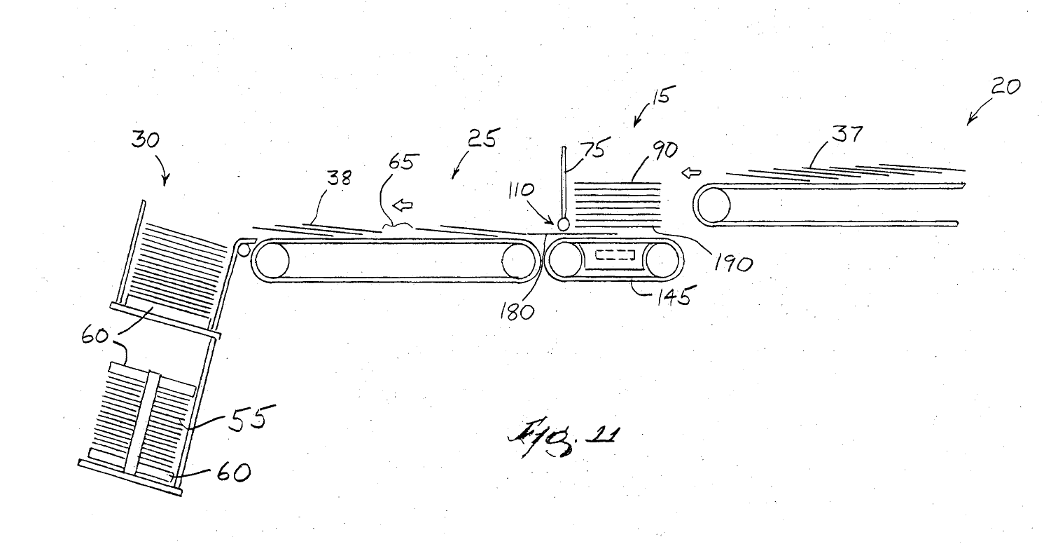

The process section 30 receives the second shingled stream of signatures 38 and further processes or uses them. As shown in FIGS. 10 and 11, the process section 30 is for example a stacker that receives the shingled stream of signatures 38 and reorganizes the signatures into a vertical stack or log 55. Once the log 55 reaches a predetermined height, the log 55 is bound and removed from the stacker 30. After the log 55 is removed, the stacker 30 begins the process with a new log 55. In many stackers 30, end boards 60 are positioned at the top and bottom of the log 55 to provide support and protect the signatures when bound. There is a time period when the completed log 55 is removed and the new log 55 is started during which the stacker 30 cannot receive signatures. The gapper section 15 is operable to produce a gap 65 (shown in FIG. 11) in the shingled stream of signatures 38 traveling to the stacker 30 that is large enough to allow for the removal of the complete log 55 and the preparation for the new log 55 (placement of the bottom end board and repositioning the log support structure to receive signatures) without slowing or stopping the input conveyor 20.

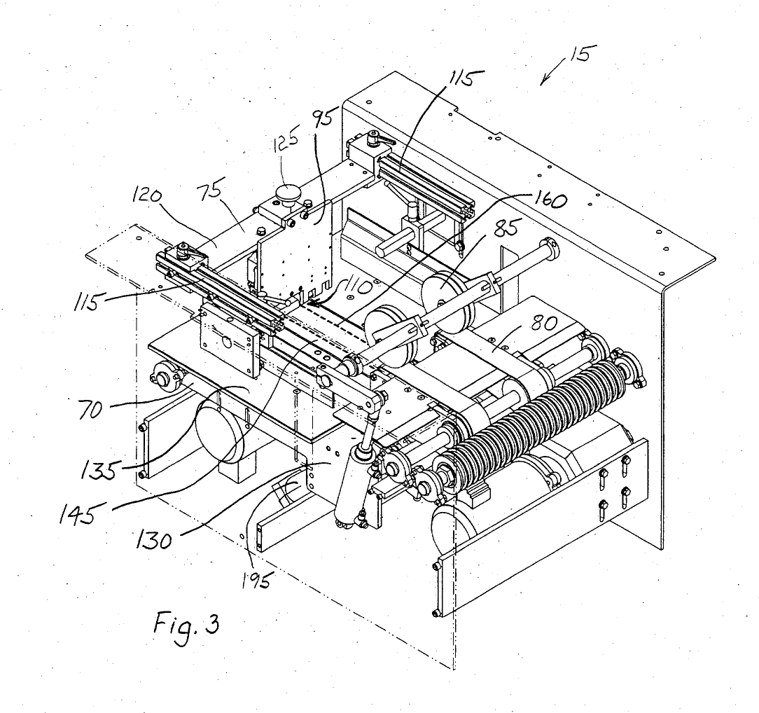

FIG. 3 illustrates the gapper section 15 of the transfer system 10. The gapper section 15 includes a support member 70, a stop member 75, and a transfer conveyor 80. The transfer conveyor 80 receives the first shingled stream of signatures 37 from the input conveyor section 20 and delivers individual signatures to the support member 70. A plurality of leaf springs 85 having free ends riding on the signatures maintain a downward pressure on the signatures so that they remain in contact with the transfer conveyor 80. In another construction illustrated in FIGS. 3-5, a pair of idler wheels maintain the downward pressure.

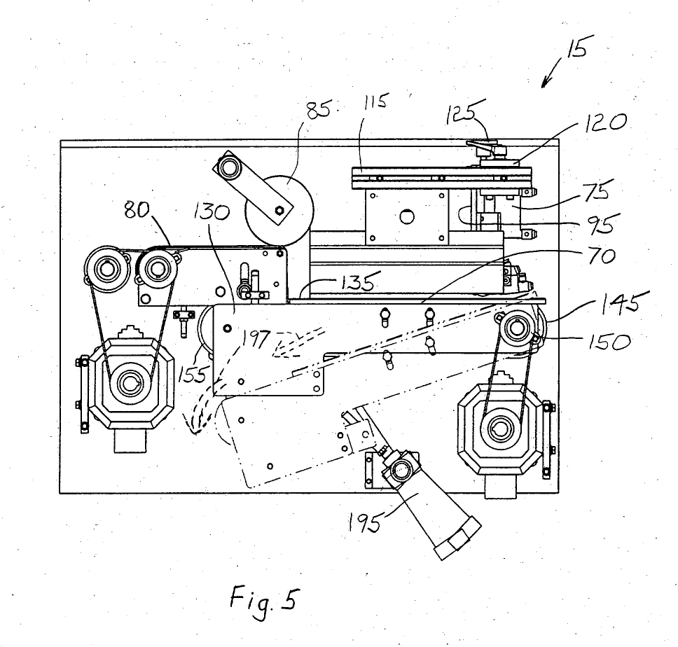

As shown in FIGS. 3 and 5, the support member 70 is positioned below the transfer conveyor 80 to allow for the accumulation of signatures into a queue 90 (FIGS. 10 and 11). The signatures exit the transfer conveyor 80 and pass over the queue 90 until they impact the stop member 75. After impacting the stop member 75 the signature's forward motion is halted and they settle onto the top of the queue 90 supported by the support member 70.

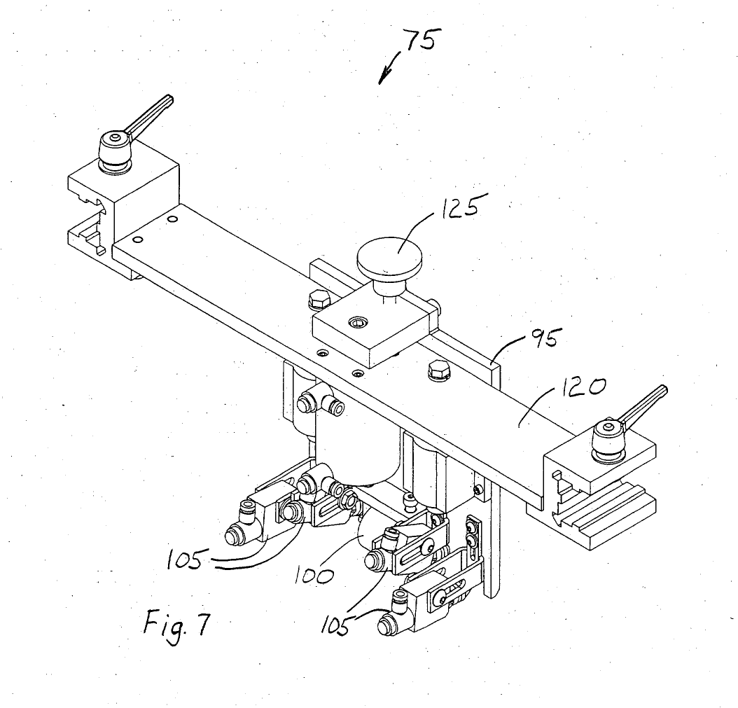

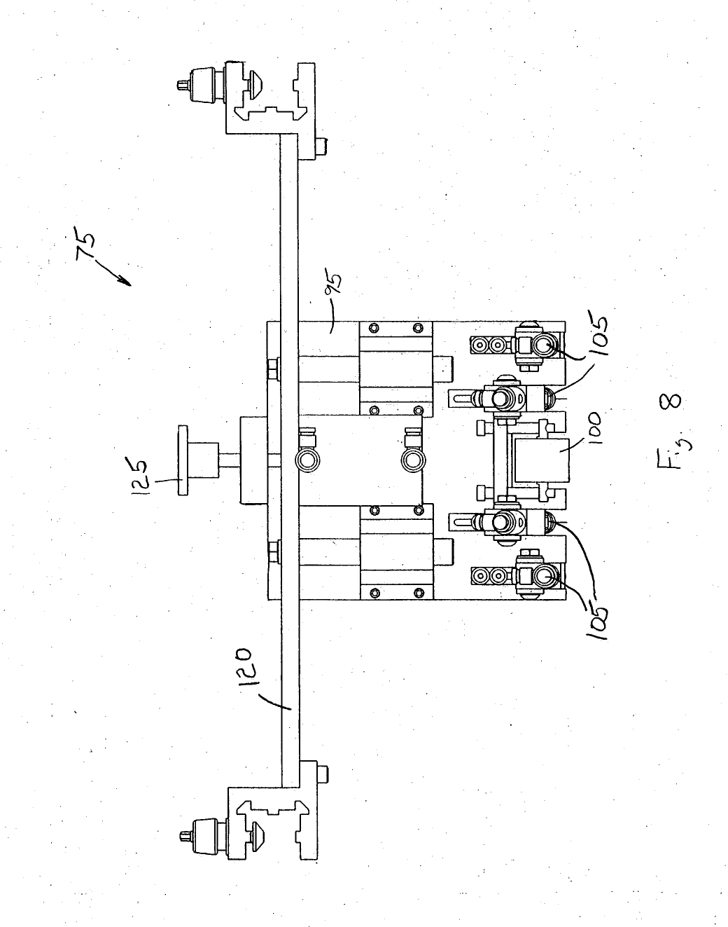

The stop member 75 includes a plate 95, a nip roller 100, and a plurality of nozzles 105, illustrated in FIGS. 7 and 8. The plate 95 is supported perpendicular to the signature travel path and above the support member 70. The plate 95 provides an impact surface for the signatures entering the queue 90. The nip roller 100 is positioned above the support member 70 to define a metering gate 110 therebetween. The plurality of air nozzles 105 direct an air stream at the leading edge of the signatures in the queue 90. The airflow aids in separating the signatures from one another in the queue 90, thus enhancing the performance of the gapper section 15.

The stop member 75 is supported within the gapper section by two linear slide members 115 and a cross beam 120. The linear slide members 115 allow for the repositioning of the plate 95 at any desired axial position to accommodate different length signatures. An adjusting screw 125 allows for the vertical adjustment of the plate position, thereby allowing for a larger or smaller opening in the metering gate 110. The adjusting screw 125 advances or retracts the plate 95 along the vertical axis. In another construction, the plate 95 attaches to the crossbeam 120 through slots in the plate 95. By loosening the screws, the plate 95 can be moved up or down along the vertical axis.

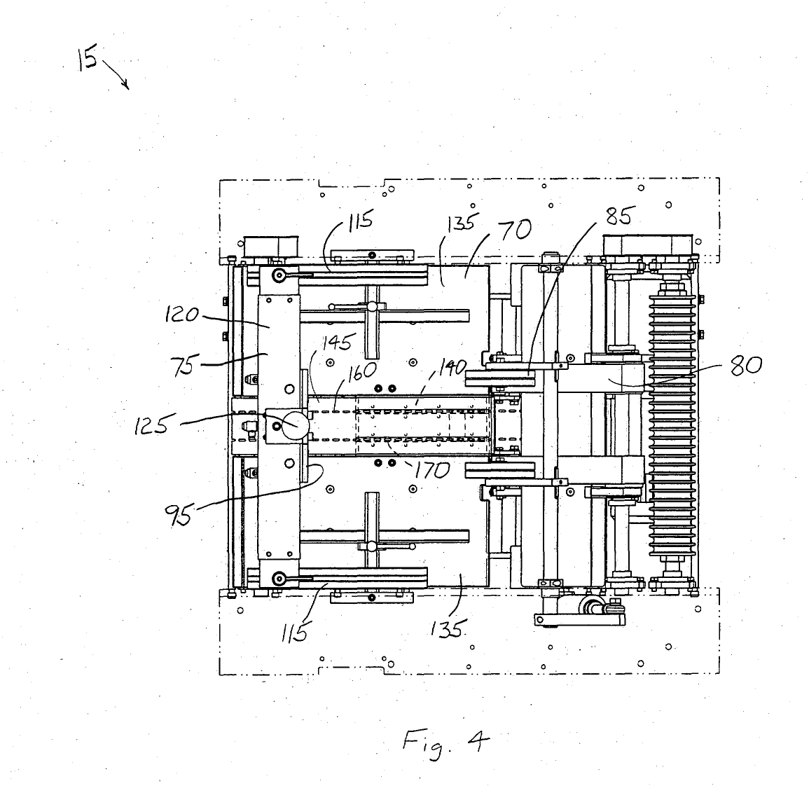

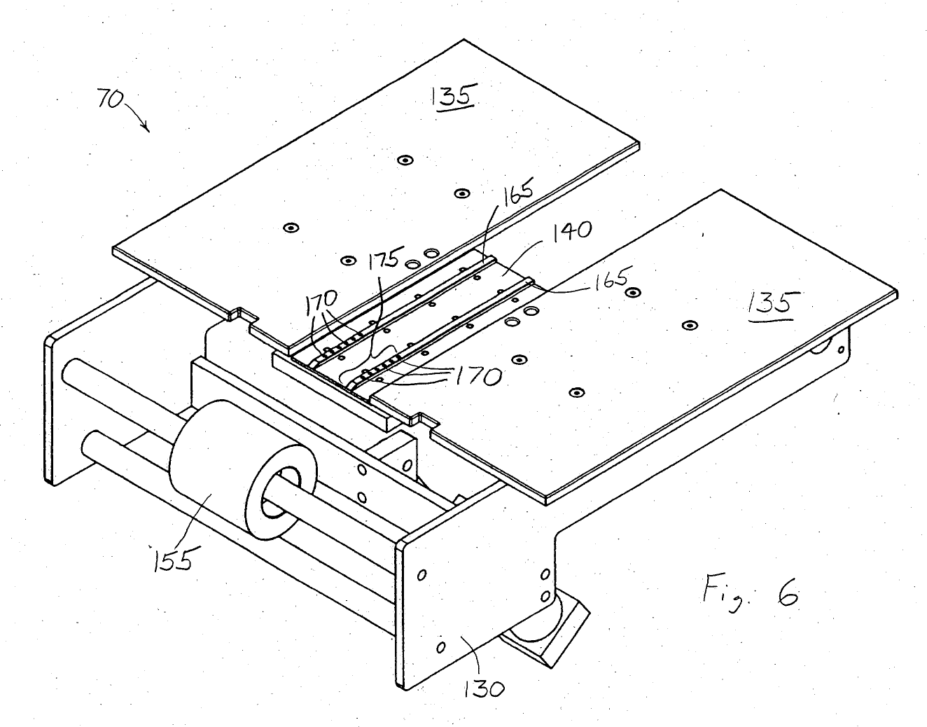

The support member 70, illustrated best in FIG. 6, includes a frame 130 that supports two support surfaces 135, a vacuum plate 140, an apertured conveyor belt 145 (shown in FIGS. 3 and 4), a drive pulley 150 (FIG. 5), and an idler pulley 155. The two support surfaces 135 are attached to the frame 130 and are spaced apart a distance to define a path therebetween. The apertured conveyor belt 145 is disposed within the path between the support surfaces 135 and is operable to individually engage the bottom surfaces of the signatures in the queue 90 and move the signatures toward the process section 30 in a shingled stream 38.

The apertured conveyor belt 145, illustrated best in FIGS. 3 and 4, is a single continuous looped belt including two rows of apertures 160. The apertures 160 are generally elongated racetrack-shaped openings with rectangular or round openings also working. The upper leg or advancement leg of the apertured belt 145 moves in an advancement direction and is operable to advance signatures. The lower leg or return leg moves in the opposite direction. In another construction, separate belts are used rather than the single belt 145 illustrated in FIGS. 3 and 4.

With reference to FIG. 5, the drive pulley 150 engages one end of the apertured conveyor belt 145, while the idler pulley 155 engages the opposite end. In some constructions, one or both of the pulleys 150, 155 are movable to allow for the adjustment of the tension in the conveyor belt 145. In other constructions, a tension pulley is operable to vary the tension in the conveyor belt 145. The drive pulley 150 is driven by a motor or another belt to rotate at the desired speed. In the construction illustrated in FIG. 5, a variable-speed electric motor connects to the drive pulley 150 through a belt drive and is operable to drive the apertured conveyor 145.

Returning to FIG. 6, the vacuum plate 140 is illustrated with the apertured conveyor belt 145 removed. The vacuum plate 140, unlike the support surfaces 135, is free to move in the direction of movement of the apertured conveyor belt 145. The movement can be manual or can be powered. In a manual system, one or more screws hold the vacuum plate 140 in the desired position. Loosening the screws allows for the adjustment of the position of the vacuum plate 140. In a powered system, a drive member 163 (e.g., hydraulic, pneumatic, or electric motor) operates to move and hold the vacuum plate 140 in the desired position.

The vacuum plate 140 includes two ribs 165 that extend the full length of the vacuum plate 140 and are substantially parallel to the direction of travel of the apertured conveyor 145. The ribs 165 extend above the surface of the vacuum plate 140 to a height slightly below the height of the support surfaces 135. The apertured conveyor 145 rides on the ribs 165 such that the upper surface of the conveyor is at or near the elevation of the support surfaces 135. The ribs 165 include a plurality of apertures 170 disposed substantially at one end to define a vacuum region 175. The apertures 170 extend through the vacuum plate 140 and provide fluid communication between the vacuum region 175 and a vacuum source.

As is best illustrated in FIG. 4, the apertures 160 in the conveyor 145 align with the ribs 165, and therefore, the apertures 170 in the vacuum plate 140. Thus, the vacuum is in fluid communication with the top of the conveyor 145 and the bottom surfaces of exposed signatures in the queue 90 in the vacuum region 175.

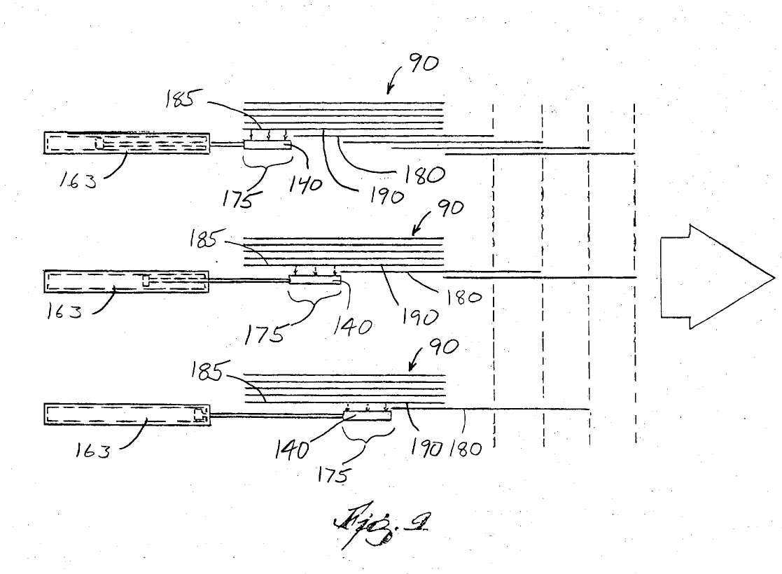

The spacing between adjacent signatures in the shingled stream 38 is controlled by moving the vacuum plate 140 forward and back relative to the stop member 75 and queue 90 as illustrated in FIG. 9. When the vacuum plate 140 is moved forward, the clutched signature 180 must move further to expose the tail 185 of the signature 190 immediately above the clutched signature 180 to the vacuum region 175, thus increasing the spacing between signatures in the shingled stream 38. When the vacuum plate 140 is moved backward (toward the tail portion 185 of the signatures in the queue 90) the clutched signature 180 moves a shorter distance to expose the tail portion 185 of the signature 190 immediately above it to the vacuum region 175, thus reducing the spacing between signatures. The change in position of the vacuum plate 140 shifts the location of the vacuum region 175, thereby changing the point at which the apertured conveyor 145 clutches the bottom surface of the exposed signature for advancement.

For example, if the vacuum plate 140 is moved forward (toward the metering gate 110) the vacuum region 175 also moves forward. The exposed bottom portion of the signatures are still clutched by the belt 145 adjacent the vacuum region 175, however, this occurs farther forward on the signature. Thus the clutched signature 180 must move further to expose the tail portion 185 of the next signature 190 to the vacuum region 175. Since each signature must move further forward before the apertured belt 145 is able to clutch the subsequent signature 190, the spacing between adjacent signatures must increase. In contrast, if the vacuum plate 140 were adjusted rearward rather than forward, a smaller spacing would follow. Again, the vacuum region 175 has shifted with the vacuum plate 140, thereby allowing the belt 145 to clutch the exposed signature 180 closer to its trailing edge. The signature 180 must travel a shorter distance to expose the tail portion 185 of the next signature 190 to a point where the apertured belt 145 can clutch it, thereby defining a shingled stream having a smaller space between adjacent signatures. Thus, the spacing between signatures can be varied between a first spacing distance and a second spacing distance independent of the spacing of the apertures 160 in the apertured conveyor 145. This allows for the use of a single belt 145 for all spacing conditions.

As shown in FIG. 5, the support member 70 attaches to the gapper section 15 along a pivot axis defined by the axis of rotation of the drive pulley 150. A cylinder 195 (for example, hydraulic or pneumatic) supports the opposite end of the support member 70 in the desired location. During operation, the cylinder 195 is extended to maintain the support member 70 in a level orientation to allow for the accumulation of the queue 90 of signatures. During a jam cycle, the cylinder 195 retracts to dump the queue 90 and any incoming signatures along a waste path 197 as indicated by the arrow. In another construction, an electric motor is used to move the support member 70 rather than the cylinder 195.

Referring to FIGS. 10 and 11, the operation and method of the system 10 will be described wherein the process section 30 is a stacker and wherein the product is a signature. However, it should be noted that the invention should not be limited to use with a stacker or with signatures. Other types of processing equipment can also be utilized as well as other types of products. The first stream of signatures 37 travels on the input conveyor 20 to the gapper section 15 as indicated by the arrows. From the gapper section 15, the second shingled stream of signatures 38 travels to the stacker 30 as indicated by the arrows.

As previously described with regard to FIG. 3-4, the first stream of signatures 37 is delivered to the transfer conveyor 80 of the gapper section 15. The transfer conveyor 80 delivers the signatures to the support member 70 to define the queue 90. Once a sufficient queue 90 is established, the apertured conveyor 145 begins moving and the vacuum is applied to the vacuum plate 140.

As the apertured belt 145 advances, the apertures 160 in the belt 145 align with the vacuum region 175, thereby allowing the apertured belt 145 to clutch the bottom portion of the exposed signature. Once clutched, the signature 180 advances exposing the tail 185 of the signature 190 immediately above the clutched signature 180. The clutched signature 180 advances to a point where the vacuum clutches the signature 190 above the clutched signature 180, thus producing the shingled stream 38. The shingled stream 38 passes beneath the metering gate 110, through the nip roller 100 and to the output conveyor 25 for delivery to the stacker 30.

Turning to FIG. 11, the apparatus is shown schematically as a log 55 nears completion. The output conveyor 25 and the apertured conveyor 145 accelerate to substantially deplete the queue 90. The apertured conveyor 145 then stops to allow the queue 90 to build up and to provide a gap 65 in the second shingled stream of signatures 38. The gap 65 is large enough to allow for sufficient time to remove the completed log 55 from the stacker 30 and to prepare the stacker 30, either manually or automatically, for another log 55. The apertured conveyor 145 restarts before the stacker 30 is fully prepared. This allows the second shingled stream 38 to arrive at the stacker 30 just as the stacker 30 is ready, thereby maximizing the productive time for the machine. In another construction, the apertured conveyor 145 continues to move but vacuum is not applied, thus preventing the conveyor 145 from clutching the lowermost signature in the queue 90. In yet another construction, the nip roller 100 stops turning to prevent the advancement of the signatures. No matter the construction used, the gapper section 15 allows for the interruption in the flow of signatures to the stacker 30 without having to vary the rate at which signatures are fed to the gapper by the input conveyor 20.

A control system coordinates the various conveyors to assure proper system operation. A microprocessor based control system is used in many constructions. However, other constructions use a simple control system consisting of sensors and relays with no programmable component whatsoever.

Sensors measure system parameters such as conveyor speed, queue height or weight, log height or weight, etc. to determine what actions if any should be taken. For example, a load cell measuring the weight of the log 55 as it is compiled may send a signal indicating the log 55 is near completion. In response to this signal, the apertured conveyor 145 accelerates momentarily to deplete the queue 90 and then stops for a predetermined length of time. Meanwhile, the output conveyor 25 accelerates to quickly deliver the last of the signatures to the log 55. As the log 55 is removed and the empty stacker 30 is prepared, the apertured conveyor 145 restarts and the output conveyor 25 resumes its normal delivery speed.

A height or weight sensor measures the height of the queue 90 and adjusts the speed of the various conveyors to maintain the desired quantity of signatures within the queue 90. The sensor may also signal an alarm or shut down the various conveyors in response to a queue 90 having substantially more signatures than desired.

Although the invention has been described in detail with reference to certain preferred embodiments, variations and modifications exist within the scope and spirit of the invention as described and defined in the following claims.

1. An apparatus comprising:
a first conveyor adapted to convey a first stream of products;
a gapper positioned adjacent the first conveyor to receive and reorient the first stream of products into a vertical queue;
a second conveyor selectively operable to clutch the bottom surface of exposed products and advance the products to define a second stream of products; and
a third conveyor receiving the second stream from the second conveyor and transferring it to a process device, the third conveyor having an operating speed that is variable and that is selectively different than the operating speed of the second conveyor.

2. The apparatus of claim 1, wherein the first conveyor delivers products at a substantially constant rate.

3. The apparatus of claim 1, wherein the first conveyor is driven by a variable speed drive.

4. The apparatus of claim 1, wherein the gapper includes a stop member positioned to deflect the products into the vertical queue.

5. The apparatus of claim 4, wherein the stop member is positioned adjacent the second conveyor to define a metering gate therebetween.

6. The apparatus of claim 1, wherein the gapper further includes a support member having first and second support surfaces.

7. The apparatus of claim 6, wherein the first and second support surfaces are spaced apart to define a conveyor space therebetween and wherein the second conveyor is disposed at least partially within the space.

8. The apparatus of claim 1, wherein the second conveyor includes a belt having a plurality of apertures therein.

9. The apparatus of claim 8, wherein the apertures are substantially equally spaced.

10. The apparatus of claim 1, wherein the second conveyor includes a variable speed drive.

11. The apparatus of claim 10, wherein the variable speed drive selectively stops advancement to prevent the second conveyor from advancing the second stream of products, thereby defining a gap.

12. The apparatus of claim 1, further comprising a vacuum plate, the vacuum plate in fluid communication with a vacuum source and cooperating with the second conveyor to selectively clutch products in the queue.

13. The apparatus of claim 12, wherein the vacuum plate is movable to vary the spacing between adjacent products within the second stream.

14. The apparatus of claim 12, wherein the fluid communication between the vacuum plate and the vacuum is selectively terminated to prevent the second conveyor from advancing products, thereby defining a gap in the second stream.

15. The apparatus of claim 1, further comprising a nip roller operable to prevent the passage of products from the vertical queue to the third conveyor.

16. The apparatus of claim 1, wherein the gapper is movable to discharge the products within the vertical queue to a waste path.

17. The apparatus of claim 1, wherein the process device includes a stacker operable to produce a log of products.

18. An apparatus operable to produce a stream of products having a desired product spacing, the apparatus comprising:
a conveyor disposed beneath a vertical queue of products, the conveyor including a plurality of substantially equally spaced apertures; and
a vacuum plate disposed beneath the conveyor, in fluid communication with a vacuum source and including a plurality of apertures alignable with the plurality of apertures of the second conveyor, the vacuum plate movable between a first position and a second position;
wherein when the vacuum plate is in the first position the second conveyor clutches an exposed bottom surface of the products in the queue to advance the products in sequence and produce a shingled stream of products having a first spacing and when the vacuum plate is in the second position the second conveyor clutches the exposed bottom surfaces of the products in the queue and advances the products in sequence to produce a shingled stream of products having a second spacing.

19. The apparatus of claim 18, further comprising a delivery conveyor operable to deliver a first shingled stream of products to the queue at a substantially constant rate.

20. The apparatus of claim 19, wherein the delivery conveyor is driven by a variable speed drive.

21. The apparatus of claim 18, further comprising a gapper section operable to receive a stream of products and reorient the products into the vertical queue.

22. The apparatus of claim 21, wherein the gapper includes a stop member positioned to deflect the products into the vertical queue.

23. The apparatus of claim 22, wherein the stop member is positioned adjacent the conveyor to define a metering gate therebetween.

24. The apparatus of claim 21, wherein the gapper further includes a support member having first and second support surfaces.

25. The apparatus of claim 24, wherein the first and second support surfaces are spaced apart to define a conveyor space therebetween and wherein the conveyor is disposed at least partially within the space.

26. The apparatus of claim 21, wherein the gapper is movable to discharge the products within the vertical queue to a waste path.

27. The apparatus of claim 18, wherein the conveyor includes a variable speed drive.

28. The apparatus of claim 27, wherein the variable speed drive selectively stops advancement to prevent the conveyor from advancing the second shingled stream of products, thereby defining a gap.

29. The apparatus of claim 18, wherein the fluid communication between the vacuum plate apertures and the vacuum source is selectively terminable to prevent the conveyor from advancing products, thereby defining a gap in the second shingled stream.

30. The apparatus of claim 18, further comprising a nip roller operable to prevent the passage of products from the vertical queue to the exit conveyor.

31. An apparatus comprising:
a first conveyor operable to deliver a first shingled stream of printed products;
a gapper positioned adjacent the first conveyor to receive the first shingled stream and reorient the printed products into a vertical queue;
a second conveyor including a plurality of apertures therein, the second conveyor having an advancement leg movable in an advancement direction;
a vacuum plate disposed beneath the advancement leg, the vacuum plate including a plurality of vacuum apertures and movable parallel to the advancement direction, the vacuum apertures being in fluid communication with a vacuum source such that the vacuum apertures cooperate with the apertures in the second conveyor to sequentially clutch and advance each of the printed products in the queue; and
a third conveyor positioned to receive the printed products from the second conveyor and delivering the printed products as a second shingled stream having a spacing.

32. The apparatus of claim 31, wherein the first conveyor delivers printed products at a substantially constant rate.

33. The apparatus of claim 31, wherein the first conveyor is driven by a variable speed drive.

34. The apparatus of claim 31, wherein the gapper includes a stop member positioned to deflect the printed products into the vertical queue.

35. The apparatus of claim 34, wherein the stop member is positioned adjacent the second conveyor to define a metering gate therebetween.

36. The apparatus of claim 31, wherein the gapper further includes a support member having first and second support surfaces.

37. The apparatus of claim 36, wherein the first and second support surfaces are spaced apart to define a conveyor space therebetween and wherein the second conveyor is disposed at least partially within the space.

38. The apparatus of claim 31, wherein the second conveyor apertures are substantially equally spaced.

39. The apparatus of claim 31, wherein the second conveyor includes a variable speed drive.

40. The apparatus of claim 39, wherein the variable speed drive selectively stops advancement to prevent the second conveyor from advancing the second shingled stream of printed products, thereby defining a gap.

41. The apparatus of claim 31, wherein the vacuum plate moves between a first position and a second position to vary the spacing between adjacent printed products within the second shingled stream of printed products.

42. The apparatus of claim 31, wherein the fluid communication between the vacuum plate and the vacuum is selectively terminable to prevent the second conveyor from advancing printed products, thereby defining a gap in the second shingled stream of printed products.

43. The apparatus of claim 31, further comprising a nip roller operable to prevent the passage of printed products from the vertical queue to the third conveyor.

44. The apparatus of claim 31, wherein the gapper is movable to discharge the printed products within the vertical queue to a waste path.

45. The apparatus of claim 31, wherein the apertures in the second conveyor are substantially equally spaced from one another and wherein movement of the vacuum plate between a first position and a second position varies the spacing between adjacent shingles in the second shingled stream between a first spacing and a second spacing independent of the spacing between the apertures in the second conveyor.

46. A method of changing the spacing between adjacent products in a stream of products, comprising:
orienting the products in a vertical queue;
passing a conveyor beneath the queue, the conveyor having a plurality of substantially equally spaced apertures;
fluidly connecting a first aperture with a vacuum source as it reaches a first point such that it clutches a first product in the queue;
advancing the conveyor to advance the first product a first distance;
exposing a portion of a second product immediately above the first product adjacent the first point;
fluidly connecting a second aperture with the vacuum source as it reaches the first point such that it clutches the exposed portion of the second product immediately above the first product and advances the second product to define a shingled stream of products; and
moving an adjusting member to move the first point relative to the queue to adjust the spacing between adjacent products in the shingled stream of products.

47. The method of claim 46, further comprising delivering an input shingled stream of products to the vertical queue.

48. The method of claim 46, wherein movement of the adjusting member changes the spacing between adjacent products independent of the speed of the conveyor and the spacing between the apertures in the conveyor.

49. The method of claim 46, further comprising interrupting the fluid communication between the vacuum source and the conveyor apertures to interrupt the shingled stream of products and define a gap.

50. The method of claim 46, further comprising stopping the conveyor to interrupt the shingled stream of products and define a gap.

51. The method of claim 46, further comprising passing the stream of products through a metering gate positioned adjacent the conveyor.

52. The method of claim 51, wherein the metering gate includes a nip roller operable to prevent the passage of the stream of products and define a gap.

53. A method of providing a gap in a shingled stream of products, comprising:
positioning a support member in the path of the shingled stream of products, the support member receiving the shingled stream from a first conveyor and reorienting them into a vertical queue supported on the support member;
operating a second conveyor having a plurality of equally spaced apertures therein;
providing a vacuum to at least one of the apertures such that the at least one aperture clutches a first product in the vertical queue and advances the product to produce a second shingled stream of products;
operating a third conveyor to conduct the second shingled stream of products away from the second conveyor; and
selectively interrupting the second shingled stream from advancing to the third conveyor to define the gap.

54. The method of claim 53, further comprising moving an adjusting member to change the spacing between adjacent products independent of the speed of the second conveyor and the spacing between the apertures in the second conveyor.

55. The method of claim 53, further comprising selectively interrupting the fluid communication between the vacuum source and the second conveyor apertures to interrupt the second shingled stream and define the gap.

56. The method of claim 53, further comprising stopping the second conveyor to interrupt the shingled stream and define the gap.

57. The method of claim 53, further comprising passing the stream of products through a metering gate positioned adjacent the conveyor.

58. The method of claim 57, wherein the metering gate includes a nip roller operable to prevent the passage of the second stream and define the gap.

59. The method of claim 53, further comprising accelerating the second conveyor to increase the size of the gap.

60. A method of producing a product log, comprising:
feeding a first stream of products to a queue;
vertically stacking the products in the queue;
removing individual products from the bottom of the queue to produce a second shingled stream of products having a spacing between adjacent products;
feeding the second shingled stream from a conveyor to a stacker;
accelerating the conveyor to substantially deplete the queue to complete the product log;
stopping the feeding of products from the queue to the conveyor to define a gap in the second shingled stream; and
restarting the feeding of products from the queue to the second shingled stream to begin a new log.

61. The method of claim 60, further comprising operating a second conveyor to remove individual products from the queue to define the second shingled stream.

62. The method of claim 61, wherein the second conveyor is selectively stopped to produce the gap in the second shingled stream.

63. The method of claim 61, further comprising applying a vacuum through apertures in the second conveyor such that the second conveyor is able to selectively clutch products in the queue.

64. The method of claim 63, wherein the connection between the vacuum and the apertures in the second conveyor is selectively broken to produce the gap in the second shingled stream.

65. The method of claim 63, further comprising moving an adjusting member to change the spacing between adjacent products in the second shingled stream independent of the speed of the second conveyor and the spacing between the apertures in the second conveyor.

66. The method of claim 60, further comprising passing the shingled stream of products through a metering gate positioned adjacent the conveyor.

67. The method of claim 66, wherein the metering gate includes a nip roller operable to prevent the passage of the second shingled stream and define the gap.
